(19) United States
(12) Patent Application Publication
(10) Pub. No.: US 2023/0361311 A1
(43) Pub. Date: Nov. 9, 2023

(54) CURRENT COLLECTORS FOR ELECTROCHEMICAL CELLS THAT CYCLE LITHIUM IONS

(71) Applicant: GM GLOBAL TECHNOLOGY OPERATIONS LLC, Detroit, MI (US)

(72) Inventors: Sayed Youssef Sayed NAGY, Troy, MI (US); Caleb REESE, Ferndale, MI (US); Andrew Clay BOBEL, Troy, MI (US)

(73) Assignee: GM GLOBAL TECHNOLOGY OPERATIONS LLC, Detroit, MI (US)

(21) Appl. No.: 17/737,744

(22) Filed: May 5, 2022

(51) Int. Cl. H01M 4/66

(52) U.S. Cl. CPC H01M 4/667; H01M 4/661; H01M 2004/021

(57) ABSTRACT

The present disclosure provides a lithiophilic-supported current collector for an electrochemical cell that cycles lithium ions. The lithiophilic-supported current collector includes a current collector substrate and a lithiophilic material. The lithiophilic material includes an element selected from the group consisting of: indium, lead, bismuth, gold, and combinations thereof. In certain variations, the lithiophilic material defines a lithiophilic layer disposed on or adjacent to one or more surfaces of the current collector substrate. In other variations, the current collector substrate has one or more porous surfaces and the lithiophilic material coats the one or more porous surfaces.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Many different materials may be used to create components for a lithium-ion battery. By way of non-limiting example, cathode materials for lithium-ion batteries typically comprise an electroactive material which can be intercalated or alloyed with lithium ions, such as lithium-transition metal oxides or mixed oxides of the spinel type, for example including spinel LiMn₂O₄, LiCoO₂, LiNiO₂, LiMn_{1.5}Ni_{0.5}O₄, LiNi_{(1-x-y)}CoₓM_{y}O₂ (where 0<x<1, y<1, and M may be Al, Mn, or the like), or lithium iron phosphates. The electrolyte typically contains one or more lithium salts, which may be dissolved and ionized in a non-aqueous solvent. Common negative electrode materials include lithium insertion materials or alloy host materials, like carbon-based materials, such as lithium-graphite intercalation compounds, or lithium-silicon compounds, lithium-tin alloys, and lithium titanate Li₄₊ₓTi₅O₁₂, where 0≤x≤3, such as Li₄Ti₅O₁₂ (LTO).

The negative electrode may also be made of a lithium-containing material, such as metallic lithium, so that the electrochemical cell is considered a lithium metal battery or cell. Metallic lithium for use in the negative electrode of a rechargeable battery has various potential advantages, including having the highest theoretical capacity and lowest electrochemical potential. Thus, batteries incorporating lithium metal anodes can have a higher energy density that can potentially double storage capacity, so that the battery may be half the size, while lasting the same amount of time as other lithium-ion batteries. Thus, lithium metal batteries are one of the most promising candidates for high energy storage systems. However, lithium metal does not readily adhere to common current collector materials, such as copper, often resulting in delamination and diminished performance and/or potential premature electrochemical cell failure. Accordingly, it would be desirable to develop materials for use in high energy lithium-ion batteries that improves adhesion, and as such, cell performance.

### SUMMARY

This section provides a general summary of the disclosure, and is not a comprehensive disclosure of its full scope or all of its features.

The present disclosure relates to current collectors having one or more lithiophilic surfaces, and methods of making and using the same.

In various aspects, the present disclosure provides a lithiophilic-supported current collector for an electrochemical cell that cycles lithium ions. The lithiophilic-supported current collector may include a current collector substrate and a lithiophilic material. The lithiophilic material may include an element selected from the group consisting of: indium, lead, bismuth, gold, and combinations thereof.

In one aspect, the lithiophilic material may define a lithiophilic layer disposed on or adjacent to one or more surfaces of the current collector substrate.

In one aspect, the current collector substrate may include a conductive material selected from the group consisting of: stainless steel, copper, and combinations thereof.

In one aspect, the lithiophilic layer may have an average thickness greater than or equal to about 5 nm to less than or equal to about 1 μm.

In one aspect, the current collector substrate may have an average thickness greater than or equal to about 1 μm to less than or equal to about 500 μm.

In one aspect, the current collector substrate may have one or more porous surfaces and the lithiophilic material coats the one or more porous surfaces.

In one aspect, the lithiophilic material may fill greater than or equal to about 80% to less than or equal to about 100% of a total porosity of the one or more porous surfaces.

In one aspect, the current collector substrate may have an average thickness greater than or equal to about 5 μm to less than or equal to about 1,000 μm. The one or more porous surfaces may occupy greater than or equal to about 1% to less than or equal to about 60% of the total thickness of the current collector substrate.

In one aspect, the current collector substrate may include a copper-zinc alloy, and the one or more porous surfaces may include copper.

In one aspect, the current collector substrate may include a copper-tin alloy, and the one or more porous surfaces may include copper.

In one aspect, the current collector substrate may include a copper-gold alloy, and the one or more porous surfaces may include copper.

In one aspect, the current collector substrate may include a copper-aluminum alloy, and the one or more porous surfaces may include copper.

In various aspects, the present disclosure provides an electrode for an electrochemical cell that cycles lithium ions. The electrode may include a current collector substrate having one or more porous surfaces that occupy greater than or equal to about 1% to less than or equal to about 60% of the total thickness of the current collector substrate, a lithiophilic material coating at least a portion of the one or more porous surfaces, and an electroactive material layer disposed on or adjacent to the lithiophilic material coating.

In one aspect, the current collector substrate may include a copper-containing alloy. The copper-containing alloy may include copper and at least one of zinc, tin, gold, and aluminum. The lithiophilic material may include an element selected from the group consisting of: indium, lead, bismuth, gold, and combinations thereof.

In one aspect, the current collector substrate may have an average thickness greater than or equal to about 5 μm to less than or equal to about 1,000 μm. The electroactive material layer may have an average thickness greater than or equal to about 50 nm to less than or equal to about 500 μm.

In one aspect, the lithiophilic material may fill greater than or equal to about 80% to less than or equal to about 100% of a total porosity of the one or more porous surfaces.

In one aspect, the electroactive material layer may include a lithium metal foil.

In various aspects, the present disclosure provides a method for preparing a lithiophilic-supported current collector. The method may include contacting at least one surface of a precursor current collector with a dealloying solution to form the lithiophilic-supported current collector. The precursor current collector may include a copper-zinc alloy or a copper-tin alloy. The dealloying solution may include a chemical etchant and a lithiophilic salt. The lithiophilic-supported current collector may include a current collector having one or more porous surfaces, where at least a portion of the one or more porous surfaces is coated with a lithiophilic material.

In one aspect, the chemical etchant may be selected from the group consisting of: hydrochloric acid, sulfuric acid, and combinations thereof.

In one aspect, the lithiophilic salt may be selected from the group consisting of: indium sulfate, indium chloride, lead sulfate, lead chloride, lead nitrate, bismuth sulfate, bismuth chloride, bismuth nitrate, gold sulfate, gold chloride, gold nitrate, and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical cell in accordance with various aspects of the present disclosure;

FIG. 2 is an illustration of an example lithiophilic current collector in accordance with various aspects of the present disclosure;

FIG. 3 is an illustration of an example current collector having a porous surface in accordance with various aspects of the present disclosure; and

FIG. 4 is an illustration of an example lithiophilic-coated current collector in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including current collectors having one or more lithiophilic surfaces. Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

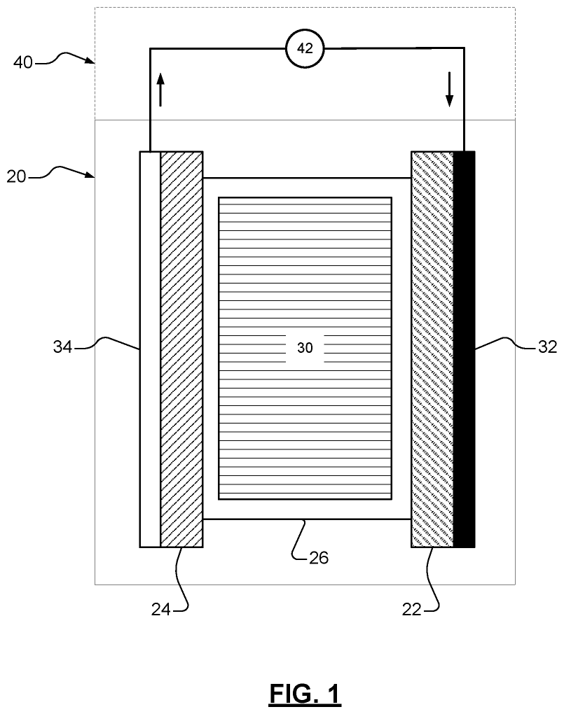

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles (not shown). The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly.

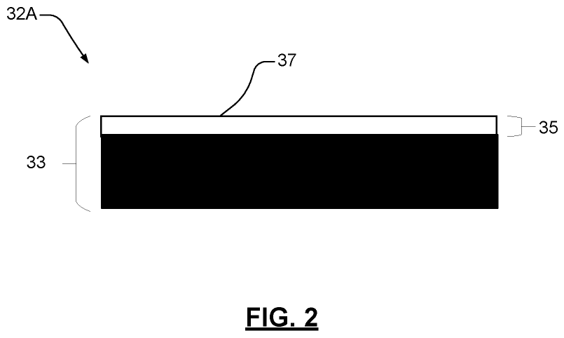

In certain variations, the first current collector 32 may be lithiophilic current collector 32A including, for example as illustrated in FIG. 2, a metallic substrate 33 having a one or more porous surfaces 35 impregnated with a lithiophilic material 37. The one or more porous surfaces 35 coated with a lithiophilic material 37 may be near or adjacent (i.e. facing) to the negative electrode 22. The metallic substrate 33 may include, for example, copper-containing alloys, such as a brass material including copper and zinc and/or a bronze material including copper and tin. In other variations, the metallic substrate 33 may include, for example, copper-containing alloys, such as copper and gold and/or copper and aluminum. As further detailed below, the one or more porous surfaces 35 may result from dealloying the zinc and/or tin and/or gold and/or aluminum at one or more surfaces of a precursor metallic substrate, and the lithiophilic material 37 may coat and/or fill at least a portion of the pores (not shown) of the one or more porous surfaces 35 so as to form the lithiophilic current collector 32A. The lithiophilic current collector 32A may have an average thickness greater than or equal to about 1 μm to less than or equal to about 500 μm, and in certain aspects, optionally greater than or equal to about 6 μm to less than or equal to about 150 μm, where the one or more porous surfaces occupy greater than or equal to about 1% to less than or equal to about 60%, optionally greater than or equal to about 2% to less than or equal to about 50%, optionally greater than or equal to about 2% to less than or equal to about 20%, and in certain aspects, optionally greater than or equal to about 2% to less than or equal to about 10%, of the total thickness. The one or more porous surfaces 35 may have a porosity greater than or equal to about 5 vol. % to less than or equal to about 80 vol. %, optionally greater than or equal to about 5 vol. % to less than or equal to about 50 vol. %, optionally greater than or equal to about 10 vol. % to less than or equal to about 50 vol. %, and in certain aspects, optionally greater than or equal to about 5 vol. % to less than or equal to about 43 vol. %. The lithiophilic material 37 may fill greater than or equal to about 80% to less than or equal to about 100% of a total porosity of the one or more porous surfaces 35.

The lithiophilic material may be selected from the group consisting of: indium, lead, bismuth, and gold, and combinations thereof. The lithiophilic-supported surface of the lithiophilic current collector 32A may improve the interfacial adhesion, and eliminate or reduce delamination, between the negative electrode 22 and the lithiophilic current collector 32A, and in particular, between copper-containing current collectors and lithium foil electrodes. Importantly, the lithiophilic material of the lithiophilic current collector 32A may react with lithium metal to form non-expanding intermetallic compounds (such as, InLi intermetallics (e.g., InLi, In₃Li₁₃, InLi₃, InLi₂ (which also has no reported volume expansion), In₂Li₃, In₄Li₅ (which has no reported volume expansion)), LiPb intermetallics (e.g., LimPb₃, PbLi₃, LiPb (which may have a volume expansion of about 49%), Li_{1.5}Pb (which may have a volume expansion of about 74%)), LiBi intermetallics (e.g., BiLi (which may have a volume expansion of about 42%), BiLi₃ (which may have a volume expansion of about 126%)), AuLi intermetallics (e.g., AuLi₃, AuLi, Au₄Li₁₅), where lithium-tin alloys commonly have volume expansions of about 244%) that supports bonding between the lithiophilic current collector 32A and the negative electrode 22. For example, in certain variations, the interfacial chemical bonding may be expected to keep at least about 90% of a total surface area of an opposing surface of the lithiophilic current collector 32A in contact with the negative electrode 22.

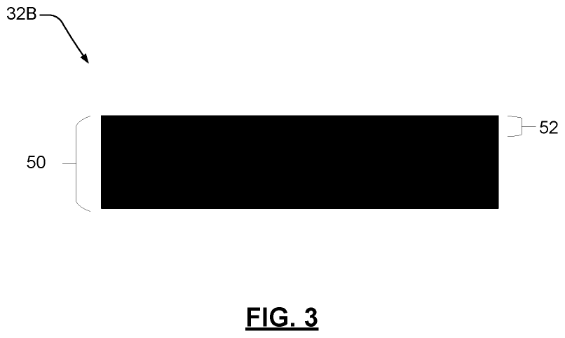

In other variations, the first current collector 32 may be a roughen current collector 32B including, for example as illustrated in FIG. 3, a metallic substrate 50 having a one or more porous surfaces 52. The one or more porous surfaces 52 may be near or adjacent (i.e. facing) to the negative electrode 22. The metallic substrate 50 may include, for example, copper-containing alloys, such as a brass material including copper and zinc and/or a bronze material including copper and tin. In other variations, the metallic substrate 50 may include, for example, copper-containing alloys, such as copper and gold and/or copper and aluminum. As further detailed below, the one or more porous surfaces 52 may result from dealloying the zinc and/or tin and/or gold and/or aluminum at one or more surfaces of a precursor metallic substrate, so as to form the roughen current collector 32B. In each variation, the roughen current collector 32B may have an average thickness greater than or equal to about 1 μm to less than or equal to about 500 μm, and in certain aspects, optionally greater than or equal to about 6 μm to less than or equal to about 150 μm, where the one or more porous surfaces occupy greater than or equal to about 1% to less than or equal to about 60%, optionally greater than or equal to about 2% to less than or equal to about 50%, optionally greater than or equal to about 2% to less than or equal to about 20%, and in certain aspects, optionally greater than or equal to about 2% to less than or equal to about 10%, of the total thickness. The one or more porous surfaces 52 may have a porosity greater than or equal to about 5 vol. % to less than or equal to about 80 vol. %, optionally greater than or equal to about 5 vol. % to less than or equal to about 50 vol. %, optionally greater than or equal to about 10 vol. % to less than or equal to about 50 vol. %, and in certain aspects, optionally greater than or equal to about 5 vol. % to less than or equal to about 43 vol. %. The roughen surface 52 may increase the surface area of the roughen current collector 32B, thereby minimizing localized distribution of the current density and reducing possible dendrite growth.

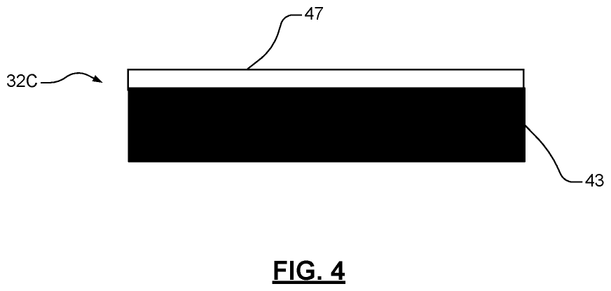

In still other variations, the first current collector 32 may be lithiophilic-coated current collector 32C including, for example as illustrated in FIG. 4, a current collector substrate 43 and one or more lithiophilic coatings 47. The one or more lithiophilic coatings 47 may be disposed on one or more exposed surfaces of the current collector substrate 43. At least one of the one or more lithiophilic coatings 47 may be near or adjacent (i.e. facing) to the negative electrode 22. In each variation, the current collector substrate 43 may have an average thickness greater than or equal to about 1 μm to less than or equal to about 500 μm, optionally greater than or equal to about 6 μm to less than or equal to about 150 μm, optionally greater than or equal to about 6 μm to less than or equal to about 50 μm, optionally greater than or equal to about 6 μm to less than or equal to about 25 μm, and in certain aspects, optionally greater than or equal to about 6 μm to less than or equal to about 10 μm; and the one or more lithiophilic coatings 47 may each have an average thickness greater than or equal to about 5 nm to less than or equal to about 1 μm, optionally greater than or equal to about 5 nm to less than or equal to about 200 nm, optionally greater than or equal to about 10 nm to less than or equal to about 100 nm, and in certain aspects, optionally greater than or equal to about 10 nm to less than or equal to about 20 nm. The current collector substrate 43 may include, for example, copper and/or stainless steel.

The one or more lithiophilic coatings 47 may each comprise a lithiophilic material selected from the group consisting of: indium, lead, bismuth, gold, and combinations thereof. Like the lithiophilic-supported surface of the lithiophilic current collector 32A, the lithiophilic-supported surface of the lithiophilic-coated current collector 32C may improve the interfacial adhesion, and eliminate or reduce delamination, between the negative electrode 22 and the lithiophilic-coated current collector 32C, and in particular, between copper-containing current collectors and lithium foil electrodes. Importantly, the lithiophilic material of the lithiophilic current collector 32C may react with lithium metal to form non-expanding intermetallic compounds (such as, InLi intermetallics (e.g., InLi, In₃Li₁₃, InLi₃, InLi₂ (which also has no reported volume expansion), In₂Li₃, In₄Li₅ (which has no reported volume expansion)), LiPb intermetallics (e.g., Li₁₀Pb₃, PbLi₃, LiPb (which may have a volume expansion of about 49%), Li_{1.5}Pb (which may have a volume expansion of about 74%)), LiBi intermetallics (e.g., BiLi (which may have a volume expansion of about 42%), BiLi₃ (which may have a volume expansion of about 126%)), AuLi intermetallics (e.g., AuLi₃, AuLi, Au₄Li₁₅), where lithium-tin alloys commonly have volume expansions of about 244%) that supports bonding between the lithiophilic current collector 32C and the negative electrode 22. For example, in certain variations, the interfacial chemical bonding may be expected to keep at least about 90% of a total surface area of an opposing surface of the lithiophilic current collector 32C in contact with the negative electrode 22.

With renewed reference to FIG. 1, a second current collector 34 (e.g., a positive current collector) may be positioned at or near the positive electrode 24. The second current collector 34 together with the positive electrode 24 may be referred to as a positive electrode assembly. The second electrode current collector 34 may be a metal foil, metal grid or screen, or expanded metal comprising stainless steel, aluminum, nickel, iron, titanium, or any other appropriate electrically conductive material known to those of skill in the art. In certain variations, the second current collector 34 may be coated foil having improved corrosion resistance, such as graphene or carbon coated stainless steel foil. The second current collector 34 may have an average thickness greater than or equal to about or exactly 2 μm to less than or equal to about or exactly 30 μm. In each variation, the first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 μm to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) layer and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂O₁₂, Li_{3X}La_{2/3-X}TiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof.

The positive electrode 24 may be formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles (not shown). Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. In certain variations, the positive electrode 24 may include a plurality of solid-state electrolyte particles (not shown). In each instance, the positive electrode 24 may have an average thickness greater than or equal to about 1 μm to less than or equal to about 500 and in certain aspects, optionally greater than or equal to about 10 to less than or equal to about 200 μm.

In various aspects, the positive electrode 24 may comprise one or more positive electroactive materials having a spinel structure (such as, lithium manganese oxide (Li₍₁₊ₓ₎Mn₂O₄, where 0.1≤x≤1) (LMO) and/or lithium manganese nickel oxide (LiMn₍₂₋ₓ₎NiₓO₄, where 0≤x≤0.5) (LNMO) (e.g., LiMn_{1.5}Ni_{0.5}O₄)); one or more materials with a layered structure (such as, lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=₁) (e.g., LiMn_{0.33}Ni_{0.33}Co_{0.33}O₂) (NMC), and/or a lithium nickel cobalt metal oxide (LiNi_{(1-x-y)}CoₓM_{y}O₂, where 0<x<0.2, y<0.2, and M may be Al, Mg, Ti, or the like); and/or a lithium iron polyanion oxide with olivine structure (such as, lithium iron phosphate (LiFePO₄) (LFP), lithium manganese-iron phosphate (LiMn₂₋ₓFeₓPO₄, where 0<x<0.3) (LFMP), and/or lithium iron fluorophosphate (Li₂FePO₄F)). In certain variations, the positive electrode 24 may comprise one or more positive electroactive materials selected from the group consisting of: NCM 111, NCM 532, NCM 622, NCM 811, NCMA, LFP, LMO, LFMP, LLC, and combinations thereof.

In certain variations, the positive electroactive material may be optionally intermingled (e.g., slurry cast) with one or more electronically conductive materials that provide an electron conductive path and/or at least one polymeric binder material that improves the structural integrity of the positive electrode 24. For example, the positive electrode 24 may include greater than or equal to about 10 wt. % to less than or equal to about 99 wt. %, and in certain aspects, optionally greater than or equal to about 60 wt. % to less than or equal to about 95 wt. %, of the positive electroactive material; greater than or equal to 0 wt. % to less than or equal to about 40 wt. %, and in certain aspects, optionally greater than or equal to about 0.5 wt. % to less than or equal to about 10 wt. %, of the electronically conducting material; and greater than or equal to 0 wt. % to less than or equal to about 40 wt. %, and in certain aspects, optionally greater than or equal to about 0.5 wt. % to less than or equal to about 10 wt. %, of the at least one polymeric binder.

Example polymeric binders include polyimide, polyamic acid, polyamide, polysulfone, polyvinylidene difluoride (PVdF), polyvinylidene difluoride (PVdF) copolymers, polytetrafluoroethylene (PTFE), polytetrafluoroethylene (PTFE) copolymers, polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 may be formed from a lithium host material that is capable of functioning as a negative terminal of a lithium-ion battery. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, in certain variations, the negative electrode 22 may include a plurality of solid-state electrolyte particles (not shown). In each instance, the negative electrode 22 (including the one or more layers) may have a thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. For example, in certain variations, the negative electrode 22 may be defined by a lithium metal foil having an average thickness greater than or equal to about 0 nm to less than or equal to about 500 μm, and in certain aspects, optionally greater than or equal to about 50 nm to less than or equal to about 50 μm. In other variations, the negative electrode 22 may include, for example only, carbonaceous materials (such as, graphite, hard carbon, soft carbon, and the like) and/or metallic active materials (such as tin, aluminum, magnesium, germanium, and alloys thereof, and the like). In further variations, the negative electrode 22 may include a silicon-based electroactive material. In still further variations, the negative electrode 22 may include a combination of negative electroactive materials. For example, the negative electrode 22 may include a combination of the silicon-based electroactive material (i.e., first negative electroactive material) and one or more other negative electroactive materials. The one or more other negative electroactive materials may include, for example only, carbonaceous materials (such as, graphite, hard carbon, soft carbon, and the like) and/or metallic active materials (such as tin, aluminum, magnesium, germanium, and alloys thereof, and the like). For example, in certain variations, the negative electrode 22 may include a carbonaceous-silicon based composite including, for example, about or exactly 10 wt. % of a silicon-based electroactive material and about or exactly 90 wt. % graphite.

In certain variations, the negative electroactive material may be optionally intermingled (e.g., slurry cast) with one or more electronically conductive materials that provide an electron conductive path and/or at least one polymeric binder material that improves the structural integrity of the negative electrode 22. For example, the negative electrode 22 may include greater than or equal to about 10 wt. % to less than or equal to about 99 wt. %, and in certain aspects, optionally greater than or equal to about 60 wt. % to less than or equal to about 95 wt. %, of the negative electroactive material; greater than or equal to 0 wt. % to less than or equal to about 40 wt. %, and in certain aspects, optionally greater than or equal to about 0.5 wt. % to less than or equal to about 10 wt. %, of the electronically conducting material; and greater than or equal to 0 wt. % to less than or equal to about 40 wt. %, and in certain aspects, optionally greater than or equal to about 0.5 wt. % to less than or equal to about 10 wt. %, of the at least one polymeric binder.

In various aspects, the present disclosure provides methods for forming lithiophilic current collectors. For example, an example method for forming a lithiophilic current collector, like the lithiophilic current collector 32A illustrated in FIG. 2, may include contacting a precursor current collector (for example, a brass current collector, including copper and zinc and/or a bronze material including copper and tin and/or another copper-containing alloy including, for example, copper and gold and/or copper and aluminum), or a surface thereof, and a chemical bath (or dealloying solution) including a chemical etchant and a lithiophilic salt in an aqueous solution. In such instances, the chemical etchant dealloys zinc and/or tin and/or gold and/or aluminum from the precursor current collector for form one or more porous surfaces, while the lithiophilic salt simultaneously deposits on the one or more porous surfaces, as a result of the redox potential of zinc and/or tin and/or gold and/or aluminum as compared with the lithiophilic material of the lithiophilic salt. For example, the redox potential of Zn/Zn²⁺ is about −0.76 V (verse standard hydrogen electrode (SHE)), while the redox potential of Bi/Biⁿ⁺ is about 0.317 V (verse standard hydrogen electrode (SHE)). In certain variations, the chemical etchant may be hydrochloric acid and/or sulfuric acid, and the lithiophilic salt may be, for example, indium sulfate, indium chloride, lead sulfate, lead chloride, lead nitrate, bismuth sulfate, bismuth chloride, bismuth nitrate, gold sulfate, gold chloride, gold nitrate, and combinations thereof.

In various aspects, the present disclosure provides methods for forming roughen current collectors. For example, an example method for forming a current collector having a porous surface, like the roughen current collector 32B illustrated in FIG. 3, may include contacting a precursor current collector (for example, a brass current collector, including copper and zinc and/or a bronze material including copper and tin and/or another copper-containing alloy including, for example, copper and gold and/or copper and aluminum), or a surface thereof, and a chemical bath (or dealloying solution) including a chemical etchant. That is, the method for forming the current collector having the porous surface may include an electrochemical etching process. In certain variations, the method may further include an annealing process, for example in the presences of an argon and/or hydrogen gas.

In various aspects, the present disclosure provides methods for forming a lithiophilic-coated current collector. For example, an example method for forming a lithiophilic-coated current collector, like the lithiophilic-coated current collector 32C illustrated in FIG. 4, may include contacting a precursor current collector, or a surface thereof, and a molten metal bath including a lithiophilic material. For example, in certain variations, the precursor current collector may be passed through the molten metal bath. In each variation, the precursor current collector may include, for example, copper and/or stainless steel, and the lithiophilic material be selected from the group consisting of: indium, lead, bismuth, gold, and combinations thereof.

In other variations, a method for forming a lithiophilic-coated current collector, like the lithiophilic-coated current collector 32C illustrated in FIG. 4, may include coating the lithiophilic material onto a precursor current collector using an electroless process. The electroless process may include contacting the precursor current collector, or a surface thereof, and a lithiophilic salt solution. In such instances, a spontaneous reaction may occur where the current collector is oxidized, releasing its cations into the solution, while the released electrons are gained by the lithiophilic cations, causing the lithiophilic material to reduce to its metal form.

In still other variations, a method for forming a lithiophilic-coated current collector, like the lithiophilic-coated current collector 32C illustrated in FIG. 4, may include using an external power source (e.g., potentiostat) to move lithiophilic cations through a current collector to a surface of a precursor current collector. In each variation, the respective method may also include cleaning the precursor current collector to remove oils and the like prior to the contacting.

In various aspects, the present disclosure provides methods for forming electrode assemblies. For example, an example method for forming an electrode assembly may include laminating one or more surfaces of a current collector—for example, the lithiophilic-supported surface of a lithiophilic current collector, like the lithiophilic current collector 32A illustrated in FIG. 2; the porous surface of a roughen current collector, like the roughen current collector 32 illustrated in FIG. 3; and/or the lithiophilic-supported surface of a lithiophilic-coated current collector, like the lithiophilic-coated current collector 32C illustrated in FIG. 4—with a lithium foil, for example, using a rolling process. In other variations, an example method for forming an electrode assembly may include plating (e.g., electroplating) one or more surfaces of a current collector—for example, the lithiophilic-supported surface of a lithiophilic current collector, like the lithiophilic current collector 32A illustrated in FIG. 2; the porous surface of a roughen current collector, like the roughen current collector 32 illustrated in FIG. 3; and/or the lithiophilic-supported surface of a lithiophilic-coated current collector, like the lithiophilic-coated current collector 32C illustrated in FIG. 4—with lithium.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lithiophilic-supported current collector for an electrochemical cell that cycles lithium ions, the lithiophilic-supported current collector comprising:
a current collector substrate; and
a lithiophilic material comprising an element selected from the group consisting of: indium, lead, bismuth, gold, and combinations thereof.

2. The lithiophilic-supported current collector of claim 1, wherein the lithiophilic material defines a lithiophilic layer disposed on or adjacent to one or more surfaces of the current collector substrate.

3. The lithiophilic-supported current collector of claim 2, wherein the current collector substrate comprises a conductive material selected from the group consisting of: stainless steel, copper, and combinations thereof.

4. The lithiophilic-supported current collector of claim 2, wherein the lithiophilic layer has an average thickness greater than or equal to about 5 nm to less than or equal to about 1 μm.

5. The lithiophilic-supported current collector of claim 2, wherein the current collector substrate has an average thickness greater than or equal to about 1 μm to less than or equal to about 500 μm.

6. The lithiophilic-supported current collector of claim 1, wherein the current collector substrate has one or more porous surfaces and the lithiophilic material coats the one or more porous surfaces.

7. The lithiophilic-supported current collector of claim 6, wherein the lithiophilic material fills greater than or equal to about 80% to less than or equal to about 100% of a total porosity of the one or more porous surfaces.

8. The lithiophilic-supported current collector of claim 6, wherein the current collector substrate has an average thickness greater than or equal to about 5 μm to less than or equal to about 1,000 μm, and the one or more porous surfaces occupy greater than or equal to about 1% to less than or equal to about 60% of the total thickness of the current collector substrate.

9. The lithiophilic-supported current collector of claim 8, wherein the current collector substrate comprises a copper-zinc alloy and the one or more porous surfaces comprises copper.

10. The lithiophilic-supported current collector of claim 8, wherein the current collector substrate comprises a copper-tin alloy and the one or more porous surfaces comprises copper.

11. The lithiophilic-supported current collector of claim 8, wherein the current collector substrate comprises a copper-gold alloy and the one or more porous surfaces comprises copper.

12. The lithiophilic-supported current collector of claim 8, wherein the current collector substrate comprises a copper-aluminum alloy and the one or more porous surfaces comprises copper.

13. An electrode for an electrochemical cell that cycles lithium ions, the electrode comprising:
a current collector substrate having one or more porous surfaces that occupy greater than or equal to about 1% to less than or equal to about 60% of the total thickness of the current collector substrate;
a lithiophilic material coating at least a portion of the one or more porous surfaces; and
an electroactive material layer disposed on or adjacent to the lithiophilic material coating.

14. The electrode of claim 13, wherein the current collector substrate comprises a copper-containing alloy comprising copper and at least one of zinc, tin, gold, and aluminum, and the lithiophilic material comprises an element selected from the group consisting of: indium, lead, bismuth, gold, and combinations thereof.

15. The electrode of claim 13, wherein the current collector substrate has an average thickness greater than or equal to about 5 μm to less than or equal to about 1,000 μm, and the electroactive material layer has an average thickness greater than or equal to about 50 nm to less than or equal to about 500 μm.

16. The electrode of claim 15, wherein the lithiophilic material fills greater than or equal to about 80% to less than or equal to about 100% of a total porosity of the one or more porous surfaces.

17. The electrode of claim 15, wherein the electroactive material layer comprises a lithium metal foil.

18. A method for preparing a lithiophilic-supported current collector, the method comprising:
contacting at least one surface of a precursor current collector comprising a copper-zinc alloy or a copper-tin alloy with a dealloying solution comprising a chemical etchant and a lithiophilic salt to form the lithiophilic-supported current collector, the lithiophilic-supported current collector comprising a current collector having one or more porous surfaces, at least a portion of the one or more porous surfaces being coated with a lithiophilic material.

19. The method of claim 18, wherein the chemical etchant is selected from the group consisting of: hydrochloric acid, sulfuric acid, and combinations thereof.

20. The method of claim 18, wherein the lithiophilic salt is selected from the group consisting of: indium sulfate, indium chloride, lead sulfate, lead chloride, lead nitrate, bismuth sulfate, bismuth chloride, bismuth nitrate, gold sulfate, gold chloride, gold nitrate, and combinations thereof.
